(19) United States
(12) Patent Application Publication
(10) Pub. No.: US 2014/0189538 A1
(43) Pub. Date: Jul. 3, 2014

(54) Recommendations for Applications Based on Device Context

(71) Applicant: MOTOROLA MOBILITY LLC, Libertyville, IL (US)

(72) Inventors: Johannes Peter Wilhelm Martens, San Francisco, CA (US); Michael D. McLaughlin, San Jose, CA (US); Simon Tietze, San Francisco, CA (US)

(73) Assignee: Motorola Mobility LLC, Libertyville, IL (US)

(21) Appl. No.: 13/769,463

(22) Filed: Feb. 18, 2013

Related U.S. Application Data
(60) Provisional application No. 61/747,555, filed on Dec. 31, 2012.

(51) Int. Cl. G06F 3/0482

(52) U.S. Cl. CPC G06F 3/0482
USPC 715/753; 715/810

(57) ABSTRACT

There is described a communication device comprising a memory, a user interface and a processor, and a method thereof. A first user interaction is detected at the user interface of the communication device with a first application of the communication device. A second user interaction is detected at the user interface of the communication device with a second application of the communication device, in which the second user interaction succeeds the first user interaction. A third application of the communication device is selected based on the first and second applications.

### FIELD OF THE INVENTION

The present invention relates generally to the field of communication devices having multiple applications and, more particularly, a mobile communication device capable of providing a recommendation for one or more of the applications of the device.

### BACKGROUND OF THE INVENTION

Users of computing devices store applications and often invoke them to complete different stages of certain tasks. As an example, a user may invoke an address book to search for a telephone number of a particular person just before invoking a telephone dialer to call that person. The order in which applications are invoked is determined by the user.

Computing devices are capable of receiving an email message and recognize text in the body of the message, such as telephone numbers, telefax numbers, and dates. A computing device can further select and run an application relevant to the recognized text, such as a telephone dialer, telefaxing program, and writable database. Also, text displayed by a computing device may be recognized as belonging to a predefined type of text and, as a result, the computing device may perform an operation based on the recognized text. Thus, computing devices are capable of selecting and running applications based on text recognized from another application or operation.

### BRIEF DESCRIPTION OF THE DRAWINGS

FIG. 1 is a perspective view of an embodiment in accordance with the present invention.

FIG. 2 is a block diagram of example components of an embodiment in accordance with the present invention.

FIG. 3 is a flow diagram of an example operation of an embodiment in accordance with the present invention.

FIG. 4 is a flow diagram of another example operation of an embodiment in accordance with the present invention.

### DETAILED DESCRIPTION OF THE EMBODIMENTS

There is disclosed a communication device, and methods thereof, for predicting an application for operation by the communication device based on relevant information. In particular, the communication device selects the application based on two or more applications previously operating, and perhaps still operating, at the communication device. By considering the two or more applications just previously viewed or otherwise used by a user of the communication device, the device has a high likelihood of predicting or selecting the next application desired by the user.

One aspect is a method of a communication device. A first user interaction is detected at a user interface of the communication device with a first application of the communication device. A second user interaction is detected at the user interface of the communication device with a second application of the communication device, in which the second user interaction succeeds the first user interaction. A third application of the communication device is selected based on the first and second applications. The first, second and/or third applications may be resident local to, or remote from, the communication device

Another aspect is another method of a communication device. An incoming message is received at a transceiver of the communication device from a remote device. The incoming message is associated with a first application of the communication device. One or more portions of the incoming message are provided at a display of the communication device. A user interaction at a user interface of the communication device with a second application of the communication device is detected. The user interaction succeeds providing the one or more portions of the incoming message at the display of the communication device. A third application of the communication device is selected based on the first and second applications. The first, second and/or third applications may be resident local to, or remote from, the communication device.

Yet another aspect is a communication device comprising a memory, a user interface and a processor. The memory is configured to store a first application, a second application and a third application. The memory may be resident local to the device, remote from the device, or distributed between local and remote locations. The user interface is configured to detect a first user interaction with the first application and a second user interaction with the second application, in which the second user interaction succeeds the first user interaction. The processor is configured to select the third application based on the first and second applications.

Still another aspect is still another method of a communication device. A first user interaction is detected at a user interface of the communication device with a first application of the communication device. A second user interaction is detected at the user interface of the communication device with a second application of the communication device, in which the second user interaction succeeds the first user interaction. A third user interaction is detected at the user interface of the communication device with a third application of the communication device, in which the third user interaction succeeds the second user interaction. A fourth application of the communication device is selected based on the first, second and third applications.

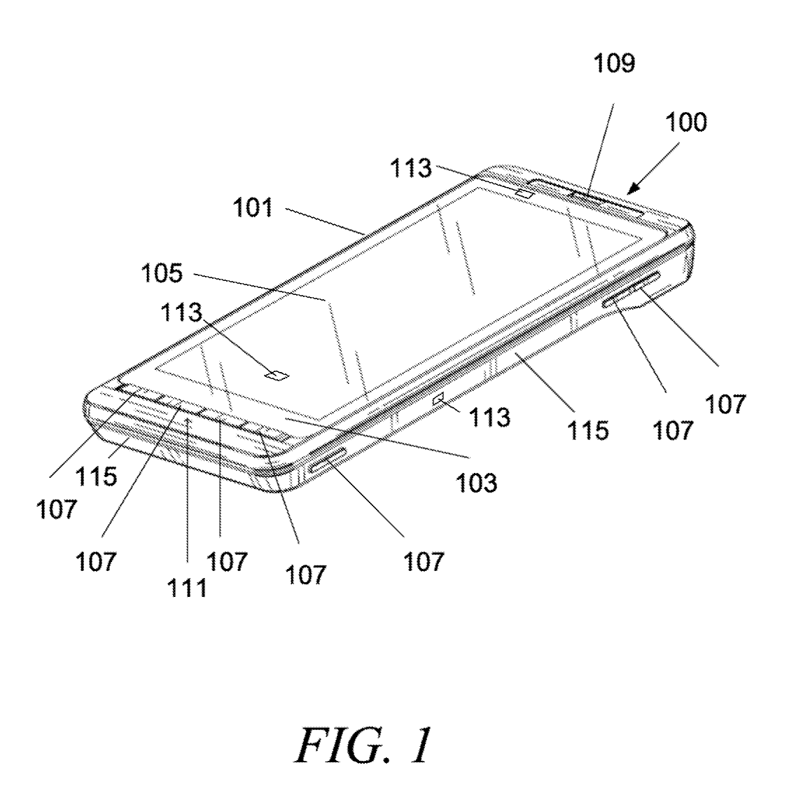

Referring to FIG. 1, there is illustrated a perspective view of an example communication device 100. The device 100 may be any type of device capable of storing and executing multiple applications. Examples of the communication device 100 include, but are not limited to, mobile devices, wireless devices, tablet computing devices, personal digital assistants, personal navigation devices, touch screen input device, touch or pen-based input devices, portable video and/or audio players, and the like. It is to be understood that the communication device 100 may take the form of a variety of form factors, such as, but not limited to, bar, tablet, flip/clam, slider and rotator form factors.

For one embodiment, the communication device 100 has a housing 101 comprising a front surface 103 which includes a visible display 105 and a user interface. For example, the user interface may be a touch screen including a touch-sensitive surface that overlays the display 105. For another embodiment, the user interface or touch screen of the communication device 100 may include a touch-sensitive surface supported by the housing 101 that does not overlay any type of display. For yet another embodiment, the user interface of the communication device 100 may include one or more input keys 107. Examples of the input key or keys 107 include, but are not limited to, keys of an alpha or numeric keypad or keyboard, a physical keys, touch-sensitive surfaces, mechanical surfaces, multipoint directional keys and side buttons or keys 107. The communication device 100 may also comprise apertures 109, 111 for audio output and input at the surface. It is to be understood that the communication device 100 may include a variety of different combination of displays and interfaces.

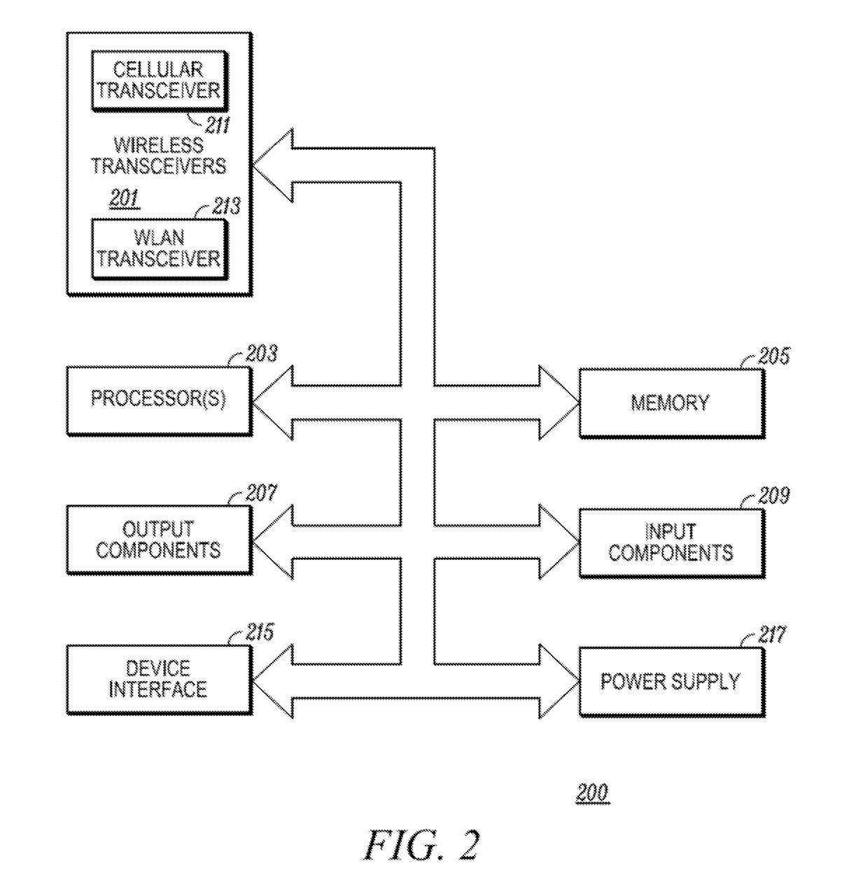

The communication device 100 includes one or more sensors 113 positioned at or within an exterior boundary of the housing 101. For example, as illustrated by FIG. 1, the sensor or sensors 113 may be positioned at the front surface 103 and/or another surface (such as one or more side surfaces 115) of the exterior boundary of the housing 101. The sensor or sensors 113 may include an exterior sensor supported at the exterior boundary to detect an environmental condition associated with an environment external to the housing. The sensor or sensors 113 may also, or in the alternative, include an interior sensors supported within the exterior boundary (i.e., internal to the housing) to detect a condition of the device itself Examples of the sensors 113 are described below in reference to FIG. 2.

Referring to FIG. 2, there is shown a block diagram representing example components 200 that may be used for one or more embodiments. The example components may include one or more wireless transceivers 201, one or more processors 203, one or more memories 205, one or more output components 207, and one or more input components 209. Each component may include a user interface that comprises one or more input components 209. Each wireless transceiver 201 may utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE, or IEEE 802.16) and their variants, as represented by cellular transceiver 211. Each wireless transceiver 201 may also utilize wireless technology for communication, such as, but are not limited to, peer-to-peer or ad hoc communications such as HomeRF, ANT, Bluetooth and IEEE 802.11 (a, b, g or n); and other forms of wireless communication such as infrared technology, as represented by WLAN transceiver 213. Also, each transceiver 201 may be a receiver, a transmitter or both.

The example components 200 may further include a device interface 215 to provide a direct connection to auxiliary components or accessories for additional or enhanced functionality. In addition, the example components 200 may include a power source or supply 217, such as a portable battery, for providing power to the other example components and allow portability of the communication device 100.

The processor 203 may generate commands based on information received from one or more wireless transceivers 201 and/or one or more input components 209. The processor 203 may process the received information alone or in combination with other data, such as the information stored in the memory 205. Thus, the memory 205 of the example components 200 may be used by the processor 203 to store and retrieve data. The data that may be stored by the memory 205 include, but is not limited to, operating systems, applications, and data. Each operating system includes executable code that controls basic functions of the communication device, such as interaction among the components of the example components 200, communication with external devices via each transceiver 201 and/or the device interface (see below), and storage and retrieval of applications and data to and from the memory 205. The memory 205 includes multiple applications, and each application includes executable code utilizes an operating system to provide more specific functionality for the communication device. Data is non-executable code or information that may be referenced and/or manipulated by an operating system or application for performing functions of the communication device.

The input components 209, such as components of the user interface, may produce an input signal in response to detecting a predetermined gesture at a first input component 219, such as a gesture sensor. An example of a gesture sensor is, but not limited to, a touch-sensitive sensor having a touch-sensitive surface substantially parallel to the display. The touch-sensitive sensor may include at least one of a capacitive touch sensor, a resistive touch sensor, an acoustic sensor, an ultrasonic sensor, a proximity sensor, or an optical sensor.

The input components 209 may also include other sensors, such as the visible light sensor, the motion sensor and the proximity sensor described above. Likewise, the output components 207 of the example components 200 may include one or more video, audio and/or mechanical outputs. For example, the output components 207 may include a video output component such as a cathode ray tube, liquid crystal display, plasma display, incandescent light, fluorescent light, front or rear projection display, and light emitting diode indicator. Other examples of output components 207 include an audio output component such as a speaker, alarm and/or buzzer, and/or a mechanical output component such as vibrating or motion-based mechanisms.

Although the input components 209 described above are intended to cover all types of input components included and/or utilized by the communication device, FIG. 2 provides a separate illustration of various sensors 225-231 that may be included and/or utilized by the device for emphasis. As shown in FIG. 2, the various sensors 225-231 may be controlled by a sensor hub 223, which may operate in response to or independent of the processor(s) 203. It is to be understood that, although the various sensors 225-231 are shown separate from the input components of 209, the various sensors are generally considered to be a part of the input components. The various sensors 225-231 may include, but are not limited to, one or more power sensors 225, one or more temperature sensors 227, one or more pressure sensors 227, one or more moisture sensors 229, and one or more motion sensors, accelerometer/Gyro sensors, and/or one or more other sensors, such as ambient noise sensors 231, light sensors, motion sensors, proximity sensors and the like.

It is to be understood that FIG. 2 is provided for illustrative purposes only and for illustrating components of a communication device in accordance with the present invention, and is not intended to be a complete schematic diagram of the various components required for a communication device. Therefore, a communication device may include various other components not shown in FIG. 2, or may include a combination of two or more components or a division of a particular component into two or more separate components, and still be within the scope of the present invention.

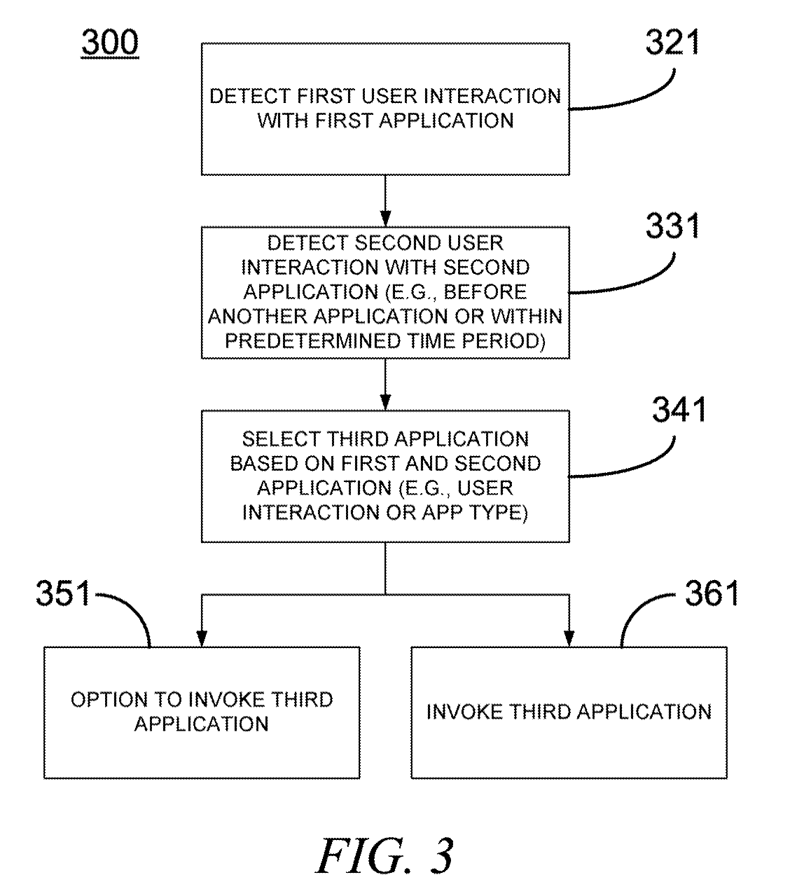

Referring to FIG. 3, there is shown a flow diagram representing an example operation 300 in accordance with one or more embodiments of the present invention. One or more components 200 of the communication device 100 monitor the operation of the device, particularly the interaction of applications and/or the type of applications. In monitoring the operation of the communication device 100, the operation 300 detects at step 321 a first user interaction at the user interface, such as input components 209, of the communication device between a user and a first application resident in the memory 205 of the communication device. For example, the user may contact or otherwise actuate the input component 209 so that the application is invoked, manipulated or brought to the forefront of the output component 207. The operation 300 then at step 331 detects a second user interaction at the user interface, such as input components 209, of the communication device 100 between the user and a second application resident in the memory 205 of the communication device. The second user interaction succeeds, i.e., follows, the first user interaction. For example, the second user interaction may succeed the first user interaction without detecting user interaction at the user interface with any other application resident in the memory 205 of the communication device 100. From the view of the user, the second application directly follows the first application without any interaction by the user of an interim application between the first and second applications. For another example, the second user interaction may succeed the first user interaction in which the first and second user interactions occur within a predetermined time period. The first and second interactions may occur within a few seconds for some embodiments, and the first and second interactions may occur in less than a minute for other embodiments.

After the two successive or consecutive user interactions between the user associated applications are detected, the operation 300 selects at step 341 a third application resident in the memory 205 of the communication device 100 based on the first and second applications. The operation 300 may select, by one or more processors 203 of the communication device 100, the third application based on the identities of the first and second applications or characteristics of the first and second applications. For example, the third application may be selected based on the first user interaction with the first application and the second user interaction with the second application. For another example, the third application may be selected based on an application type of the first application and an application type of the second application, depending upon the embodiment. For one embodiment, the first application type may be one of a text communication application or a scheduling application. Examples of text communication applications include, but are not limited to, email applications, texting applications, and instant messaging applications. Examples of scheduling applications include, but are not limited, calendar applications, planning applications, task-based applications, time management applications, and applications having user alert capabilities. For this embodiment or another embodiment, the second application type may be a contact list application. Examples of contact list applications includes, but are not limited to, address book applications that includes various types of communication addresses such as email addresses, telephone numbers, IP addresses, mailing addresses, and aliases for the same. For one or both of these embodiments or another embodiment, an application type of the third application may be a voice communication application. Examples of voice communication applications include, but are not limited to, voice dialer applications or VOIP-based applications.

After selecting the third application, the operation 300 performs a function associated with the third application based on the first and second applications. For example, the operation 300 may provide an option at an output component 207, such as a display, of the communication device 100 to invoke the third application resident in the memory 205 of the communication device in response to selecting the third application. For another example, the operation 300 may invoke the third application resident in the memory 205 of the communication device 100 in response to selecting the third application.

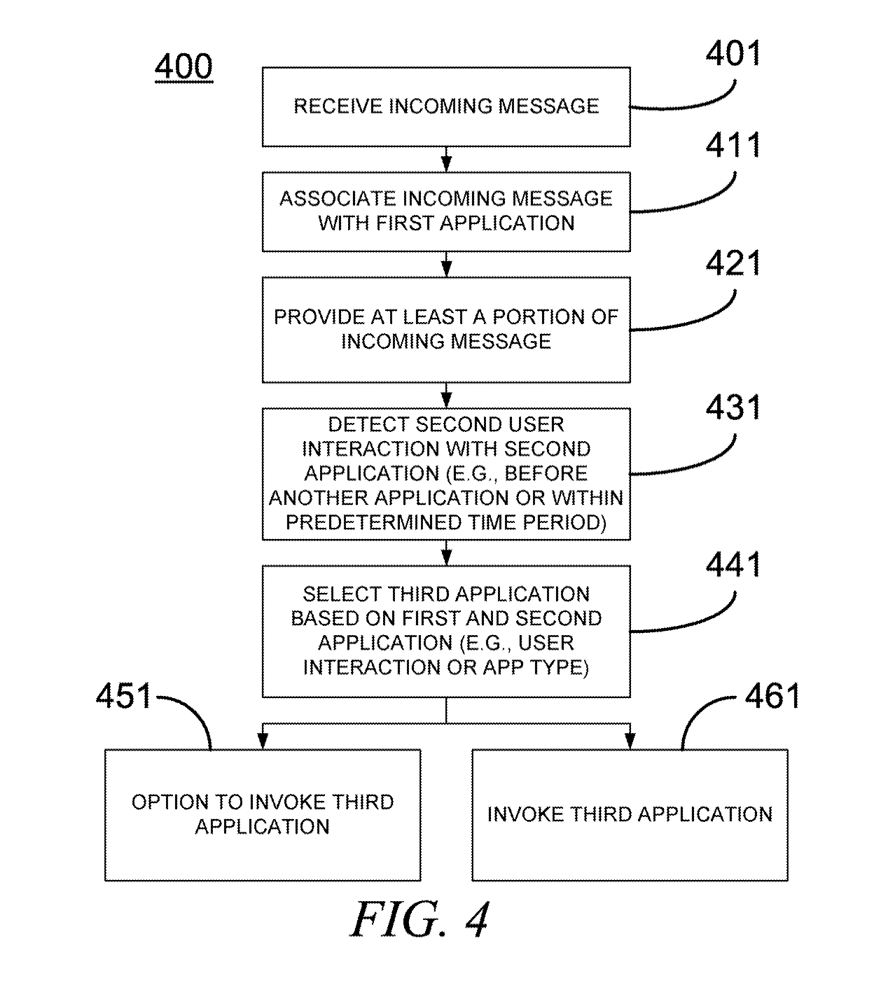

Referring to FIG. 4, there is shown a flow diagram representing another example operation 400 in accordance with one or more embodiments of the present invention. Example operation 400 is similar to example operation 300, but operation 400 identifies the first application without detecting user interaction with the first application. In monitoring the operation of the communication device 100, the operation 400 receives at step 401 an incoming message at a transceiver 201 of the communication device 100 from a remote device, such as another communication device or network infrastructure. The operation 400 then associates at step 411 the incoming message with the first application resident in the memory 205 of the communication device 100. This association may be performed by one or more processors 203, or some other component, of the communication device. Also, in response to receiving 401 the incoming message or associating 411 the incoming message with the first application, the operation 400 may provide at 421 at least a portion of the incoming message to an output component 207, such as a display, of the communication device 100. As a result, the application, or a portion thereof, may be at a forefront of the output component 207 for viewing by the user.

The operation 400 then at step 431 detect a user interaction at the user interface, such as input components 209, of the communication device 100 between the user and a second application resident in the memory 205 of the communication device. For example, the user may contact or otherwise actuate the input component 209 so that the application is invoked, manipulated or brought to the forefront of the output component 207. The user interaction succeeds, i.e., follows, providing the incoming message, or a portion thereof For example, the user interaction may succeed providing the incoming message, or a portion thereof, without detecting user interaction at the user interface with any other application resident in the memory 205 of the communication device 100. From the view of the user, the second application directly follows viewing of the first application, or a portion thereof, without any interaction by the user of an interim application between the first and second applications. For another example, the user interaction may succeed viewing of the first application in which the providing and the user interaction may occur within a predetermined time period, such as within a few seconds, less than a minute for other embodiments, or some other predetermined period of time.

Thereafter, the operation 400 selects at step 441 a third application resident in the memory 205 of the communication device 100 based on the first and second applications. The operation 400 may select, by one or more processors 203 of the communication device 100, the third application based on the identities of the first and second applications or characteristics of the first and second applications. For example, the third application may be selected based on a characteristic of the first application and the second user interaction with the second application. For another example, the third application may be selected based on an application type of the first application and an application type of the second application, depending upon the embodiment. For one embodiment, the first application type may be one of a text communication application or a scheduling application. Examples of text communication applications include, but are not limited to, email applications, texting applications, and instant messaging applications. Examples of scheduling applications include, but are not limited, calendar applications, planning applications, task-based applications, time management applications, and applications having user alert capabilities. For this embodiment or another embodiment, the second application type may be a contact list application. Examples of contact list applications includes, but are not limited to, address book applications that includes various types of communication addresses such as email addresses, telephone numbers, IP addresses, mailing addresses, and aliases for the same. For one or both of these embodiments or another embodiment, an application type of the third application may be a voice communication application. Examples of voice communication applications include, but are not limited to, voice dialer applications or VOIP-based applications.

After selecting the third application, the operation 400 performs a function associated with the third application based on the first and second applications. For example, the operation 300 may provide an option at an output component 207, such as a display, of the communication device 100 to invoke the third application resident in the memory 205 of the communication device in response to selecting the third application. For another example, the operation 400 may invoke the third application resident in the memory 205 of the communication device 100 in response to selecting the third application.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of a communication device comprising:
detecting a first user interaction at a user interface of the communication device with a first application of the communication device;
detecting a second user interaction at the user interface of the communication device with a second application of the communication device, wherein the second user interaction succeeds the first user interaction; and
selecting a third application of the communication device based on the first and second applications.

2. The method of claim 1, further comprising providing an option at a display of the communication device to invoke the third application of the communication device in response to selecting the third application.

3. The method of claim 1, further comprising invoking the third application of the communication device in response to selecting the third application.

4. The method of claim 1, wherein the second user interaction succeeds the first user interaction without detecting user interaction at the user interface with any other application of the communication device.

5. The method of claim 1, wherein the second user interaction succeeds the first user interaction by the first and second user interactions occurring within a predetermined time period.

6. The method of claim 1, wherein the third application is selected based on the first user interaction with the first application and the second user interaction with the second application.

7. The method of claim 1, wherein the third application is selected based on an application type of the first application and an application type of the second application.

8. The method of claim 1, wherein the first application type is one of a text communication application or a scheduling application.

9. The method of claim 1, wherein the second application type is a contact list application.

10. The method of claim 1, wherein an application type of the third application is a voice communication application.

11. A method of a communication device comprising:
receiving at a transceiver of the communication device an incoming message from a remote device;
associating the incoming message with a first application of the communication device;
providing at least a portion of the incoming message at a display of the communication device;
detecting a user interaction at a user interface of the communication device with a second application of the communication device, wherein the user interaction succeeds providing the at least a portion of the incoming message at the display of the communication device; and
selecting a third application of the communication device based on the first and second applications.

12. The method of claim 15, further comprising providing an option at a display of the communication device to invoke the third application of the communication device in response to selecting the third application.

13. The method of claim 15, further comprising invoking the third application of the communication device in response to selecting the third application.

14. The method of claim 15, wherein the third application is selected based on a characteristic of the first application and the second user interaction with the second application.

15. The method of claim 15, wherein the third application is selected based on an application type of the first application and an application type of the second application.

16. A communication device comprising:
a memory configured to store a first application, a second application and a third application;
a user interface configured to detect a first user interaction with the first application and a second user interaction with the second application, wherein the second user interaction succeeds the first user interaction; and
a processor configured to select the third application based on the first and second applications.

17. The communication device of claim 16, further comprising a display configured to provide an option to invoke the third application in response to the processor selecting the third application based on the first and second applications.

18. The communication device of claim 16, further comprising a display configured to provide a portion of the third application in response to the processor selecting the third application based on the first and second applications.

19. The communication device of claim 16, wherein the processor selects the third application based on the first user interaction with the first application and the second user interaction with the second application.

20. The communication device of claim 16, wherein the processor selects the third application based on an application type of the first application and an application type of the second application.
